(19) United States
(12) Patent Application Publication
(10) Pub. No.: US 2002/0139964 A1
(43) Pub. Date: Oct. 3, 2002

(54) Jack lifting arm with a changeable auxiliary disk

(76) Inventor: Michael Hung, Lu Chu Hsiang (TW)

Correspondence Address: VARNDELL & VARNDELL, PLLC, 106-A South Columbus Street, Alexandria, VA, 22314, US

(21) Appl. No.: 09/817,165

(22) Filed: Mar. 27, 2001

(51) Int. Cl. B66F 3/00

(52) U.S. Cl. 254/8 B

(57) ABSTRACT

A jack lifting arm with a changeable auxiliary disk is disclosed. The primary disk of the jack lifting arm is formed as an annular groove. At least one auxiliary disks is formed for being selected freely by the primary disk. Thereby, the height of the top disk of the jack lifting arm is changeable as desired. Therefore, as the jack is used to lift a heavy object. The primary disk may be connected with the auxiliary disk so that the front travelling length in the jack without carrying any object is reduced.

### FIELD OF THE INVENTION

The present invention relates to a jack lifting arm with a changeable auxiliary disk. The primary disk of the jack lifting arm is formed with an annular groove which can be connected with an auxiliary disk of a selected height so that the front travelling length of the jack without carrying any object is reduced.

### BACKGROUND OF THE INVENTION

The conventional jacks (including jacks of a lying type, a stand type, a scissors type or other types) has a lifting arm 20 for lifting heavy object. The front end of the prior art jack lifting arm 20 is integrally formed or firmly secured with a top disk 30 which can contact a heavy object and then lift the object. In fact, as a jack is operated, since the position of the heavy object and the top disk of the jack has level difference, before contacting with the heavy object, a distance is existed between the top disk and the heavy object, so that the front travelling length of the jack dose not carry any object. However, in this length, the user remains to operate a joystick 40 or tread a pedal so that the lifting arm 20 lifts gradually. After contacting with the object, the work of lifting heavy object is executed.

### SUMMARY OF THE INVENTION

Accordingly, the primary object of the present invention is to provide a jack lifting arm with a changeable auxiliary disk. The primary disk of the jack lifting arm is formed with an annular groove. At least one auxiliary disks are formed for being selected freely by the primary disk. Thereby, the height of the top disk of the jack lifting arm is changeable as desired. Therefore, as the jack is used to lift a heavy object. The primary disk may be connected with the auxiliary disk so that the front travelling length in the jack without carrying any object is reduced.

The various objects and advantages of the present invention will be more readily understood from the following detailed description when read in conjunction with the appended drawing.

### BRIEF DESCRIPTION OF THE DRAWINGS

FIG. 1 is a perspective view of a conventional lying type jack.

FIG. 2 is a perspective view showing that the jack lifting arm is installed with a primary disk.

FIG. 3 is an exploded perspective view of the primary disk and an auxiliary disk of the present invention.

FIG. 4 is an assembly perspective view of the primary disk and the auxiliary disk of the present invention.

FIG. 5 is an assembled cross sectional view of the primary disk and auxiliary disk of the present invention.

FIG. 6 is an assembled schematic view showing that in the present invention, different auxiliary disks are selected.

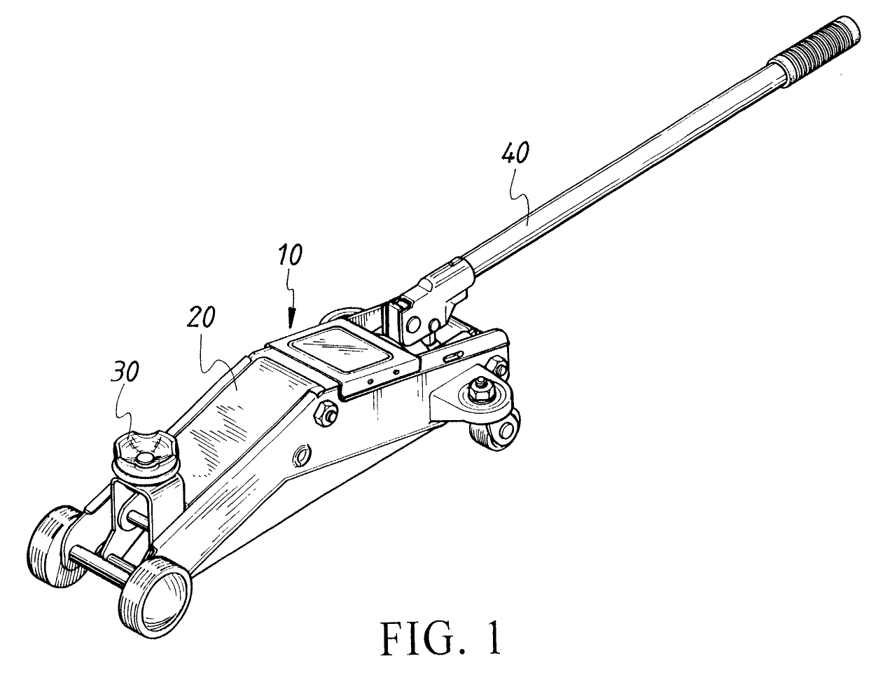

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

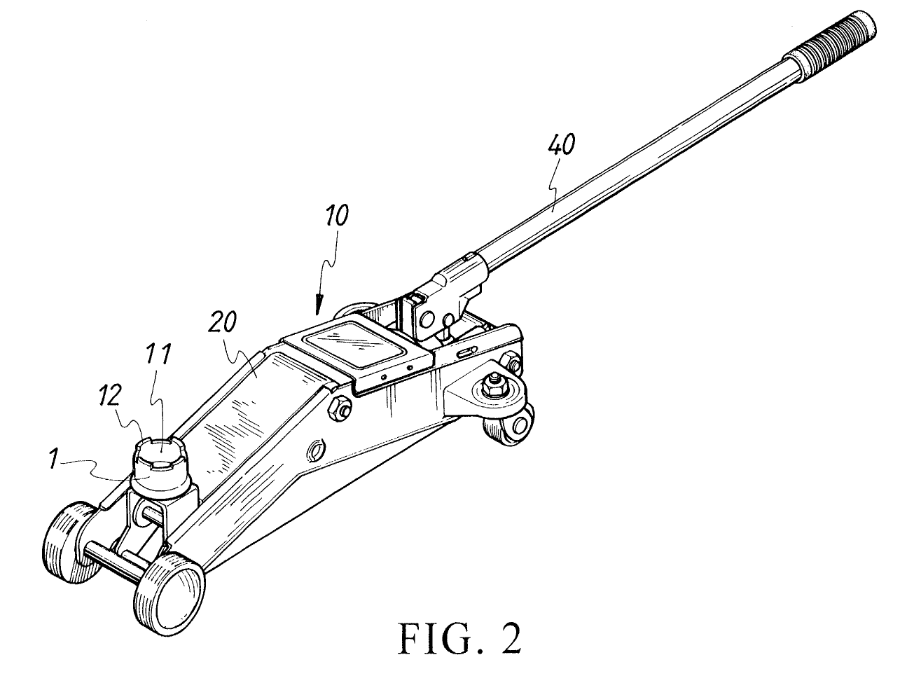

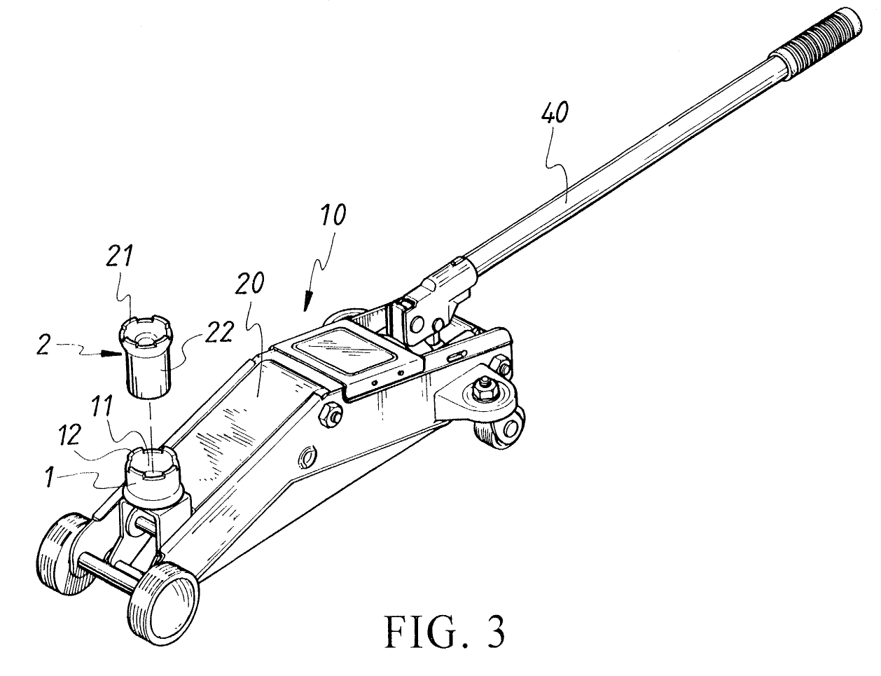

With reference to FIGS. 2 and 3, the jack lifting arm with a changeable auxiliary disk of the present invention is illustrated. The present invention may be used to jacks 10 of lying type, stand type, scissors type or other types. Especially, a front end of the lifting arm 20 is installed with a primary disk 1. Thereby, the height of the primary disk 1 of the lifting arm 20 is changeable. The lifting arm 20 has the following components.

A primary disk 1 is integrally formed or firmly secured to a front end of the lifting arm 20 of the jack. The primary disk has a hollow annular groove 11. The upper end of the peripheral wall is formed with a disk surface 12 with wave-like edge. In general, the surface can be provided to support heavy object.

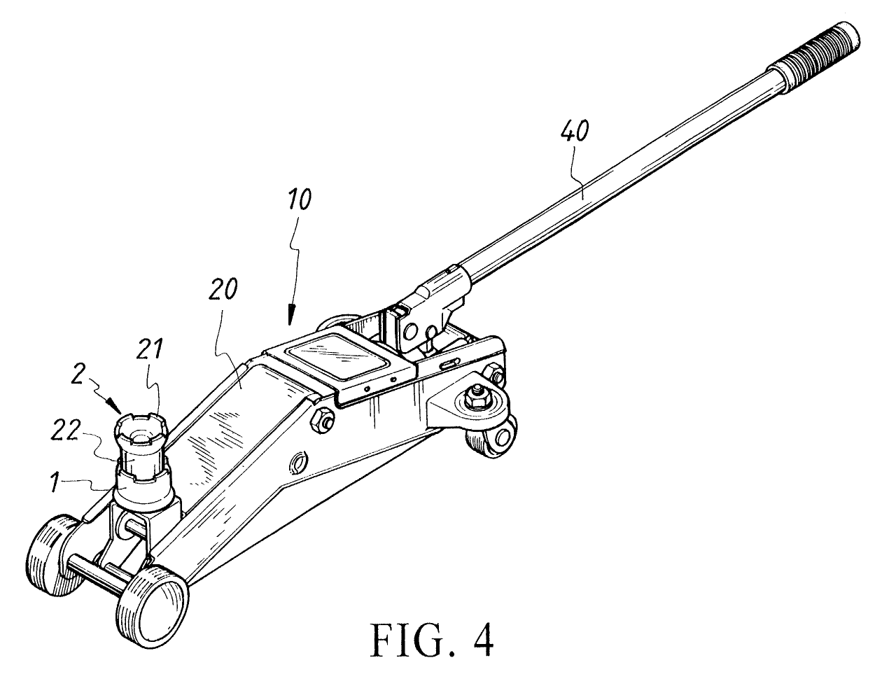

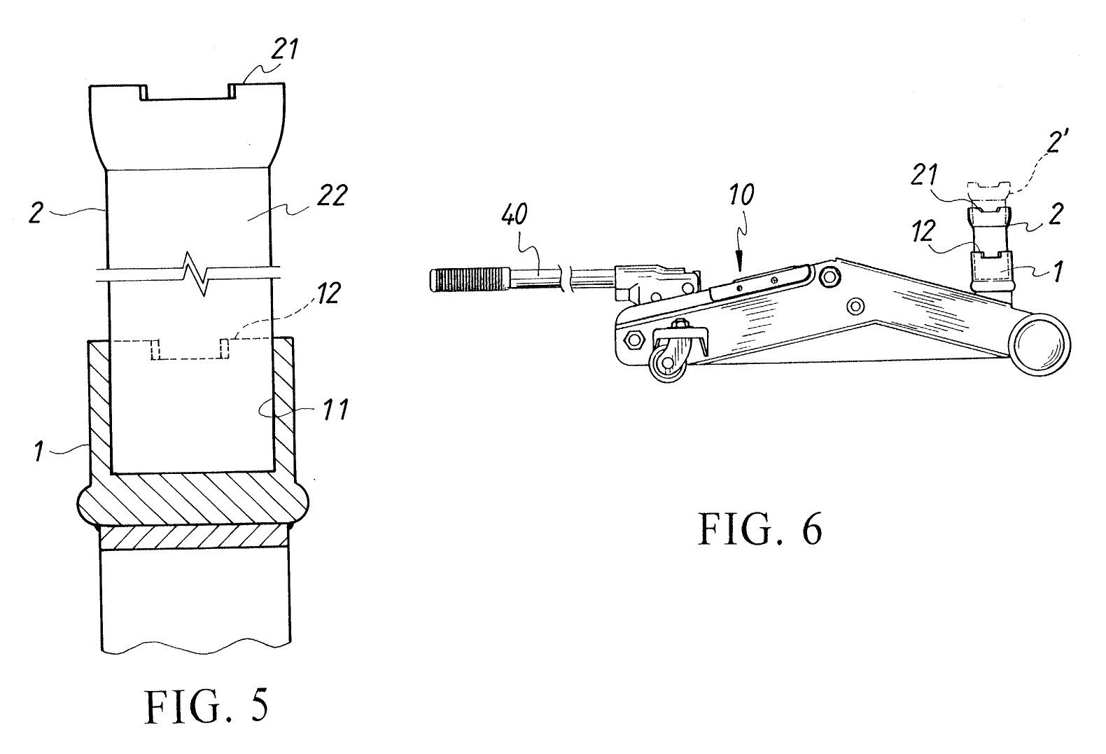

At least one auxiliary disk 2 is installed. Different auxiliary disks 2 have different forms. Various auxiliary disks 2 must have different heights for matching the primary disk 1. The auxiliary disk 2 has an upper disk surface 21 and a lower cylinder 22. The lower cylinder 22 is exactly planted into the hollow annular groove 11 of the primary disk and thus is steadily combined therein (referring to FIGS. 4 and 5).

By the construction of the primary disk 1 and the auxiliary disks 2, the annular primary disk 1 may select auxiliary disks 2 and 2′ of different heights and then the two are combined (referring to FIG. 6). The height of the primary disk 1 of the lifting arm 20 may be changed as desired so that as the jack lifts an object; it may be connected with the auxiliary disk 2 according to the position of the heavy object and the level difference of the disks of the jack so as to reduce the front travelling length in the jack without carrying any object. Therefore, it may access to a heavy object conveniently for lifting the object easily. The user is unnecessary to lift the object by manually operating a joystick 40 or treading a pedal. In the present invention, the auxiliary disk 2 and the heavy object may contact with one another rapidly.

In summary, in the present invention, the primary disk with a hollow annular groove is matched to the auxiliary disk with a selected height so that the front travelling length in the jack without carrying any object is reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A jack lifting arm with a changeable auxiliary disk having a primary disk installed in front of a lifting arm of a jack and at least one auxiliary disk; characterized in that:
the primary disk is integrally formed or firmly secured to a front end of the lifting arm of the jack; the primary disk has a hollow annular groove; and a peripheral wall thereof is formed with a top disk surface; and
the auxiliary disks have different forms; various auxiliary disks have different heights for matching with the primary disk; the auxiliary disk has an upper disk surface and a lower cylinder; the lower cylinder is exactly inserted into the hollow annular groove of the primary disk and thus is steadily combined therein; by the construction of the primary disk and the auxiliary disks, the annular primary disk selects auxiliary disks of different heights and then the two are combined; therefore, a height of the primary disk of the lifting arm is changeable as desired so as to reduce the front travelling length in the jack without carrying any object.

2. The jack lifting arm with a changeable auxiliary disk as claimed in claim 1, wherein the top disk of the primary disk has a wave-like edge.
